(19) United States
(12) Patent Application Publication
(10) Pub. No.: US 2026/0234038 A1
(43) Pub. Date: Aug. 13, 2026

(54) COMPOSITIONS AND METHODS FOR THE SOLID-LIQUID SEPARATION OF SUSPENDED FISH SOLIDS IN WATER

(71) Applicant: SOLENIS TECHNOLOGIES, L.P., Wilmington, DE (US)

(72) Inventors: Zorayma Valencia López, Lima (PE); Rogério Issa Pedro, Lima (PE); Reginaldo De Oliveira, São Paulo (BR)

(73) Assignee: SOLENIS TECHNOLOGIES, L.P., Wilmington, DE (US)

(21) Appl. No.: 19/533,996

(22) Filed: Feb. 9, 2026

Related U.S. Application Data
(60) Provisional application No. 63/755,324, filed on Feb. 7, 2025.

(51) Int. Cl. C02F 1/56; C02F 1/00; C02F 1/52; C02F 101/30; C02F 103/08

(52) U.S. Cl. CPC C02F 1/56; C02F 1/001; C02F 1/5236; C02F 2101/30; C02F 2103/08

(57) ABSTRACT

The present disclosure provides for compositions and methods for adequate clarification of water containing suspended fish solids, such as pumping water. The present composition can be used in solid-liquid separation processes, such as when making fishmeal or flour in the fish industry. The method involves treating water containing suspended fish solids, such as pumping water. The method includes adding an organic coagulant to the pumping water followed by one or more flocculants. The composition can be added to a suspension of water to aid in the solid-liquid separation of fish fat from the total soluble solids in pumping water when making, for example, fishmeal or flour.

### CROSS-REFERENCE TO RELATED APPLICATIONS

This application claims the benefit of U.S. Provisional Patent Application No. 63/755,324, filed 7 Feb. 2025, the entire contents of which are hereby incorporated by reference.

### TECHNICAL FIELD

The present disclosure generally relates to compositions and methods for the solid-liquid separation of pumping water when making fishmeal or flour in the fishing industry. More particularly, a composition that includes an organic coagulant and a flocculant may be added, in the chemical treatment, to a suspension of pumping water to aid in the solid-liquid separation process of total soluble solids in the pumping water during fishmeal processing.

### BACKGROUND

A fishmeal plant is a specialized facility where fish by-products and whole fish are processed into fishmeal and fish oil. This process transforms raw fish materials into a high-protein, nutrient-dense product widely used in animal feeds, aquaculture, and fertilizers.

Fish byproducts have been used historically to feed poultry, pigs, and other farmed fish. Fishmeal or fish flour, which terms are used interchangeably, can be made from almost any type of seafood, but is generally manufactured from wild-caught, small marine fish that contain a high percentage of bones and oil. Previously, these fish have been considered unsuitable for direct human consumption, but more recent research indicates the vast majority of fishmeal made from whole wild-caught fish is made from fish suitable for direct human consumption. Other sources of fishmeal are from bycatch and byproducts of trimmings made during processing (fish waste or offal) of various seafood products destined for direct human consumption.

After catching fresh fish on the high seas, the fish are placed in the hold of the vessel. In order to remove the fish from the hold, sea water is added to the hold, and using a vacuum pipe or a helical screw, the fish and seawater is transferred to the processing plant.

In this transfer, fat, solids, and among other types of soluble solids; are released. The fish are broken down resulting in a water suspension of fish fat or oil, fish remains, and colloidal particles called pumping water. The separation process of suspended solids is complicated when the water to be treated has a high content of suspended fish solids and fish fat or fish oil (used interchangeably throughout). Fat recovery through pumping water treatment processes (PAMA) is carried out by grease traps in a physical mechanism (difference in density) and a chemical mechanism. The recovery of solids through pumping water treatment processes (PAMA) is carried out by a chemical mechanism, which requires equipment and the addition of chemicals in adequate doses for the recovery of solids and the clarification of water in order to achieve compliance with the maximum permissible limits at an environmental level.

Currently, inorganic coagulants such as ferric sulphate are being used in combination with flocculants for the treatment of the pumping water, pumping water, or effluent from fish processing plants. The terms pumping water, pumping water, and effluent are used interchangeably herein. A dehydrated cake results from the recovery of solids from the treatment of the pumping water returns to the main process of fishmeal production. Currently, this cake has a residual of Fe+3 obtained by the addition of ferric sulphate in the treatment of solids, which favors the oxidation of fats in the final fishmeal. To slow down oxidation and prolong the shelf life of fishmeal, antioxidants are used, ethoxyquin was chosen for many years as the chemical of choice to obtain a fishmeal that meets the quality and transport conditions required by the market.

However, due to European regulations, in 2018 the use of inorganic antioxidants such as ethoxyquin, was prohibited and the market need to find an alternative system, e.g., organic antioxidants. The industry began using a blend of butylated hydroxytoluene (BHT)/butylated hydroxyanisole (BHA) as the antioxidant, which caused changes in the temperature stability of fishmeal, due to the low effectiveness of the antioxidant itself (BHT/BHA).

Over the years it became evident that the duality of ferric sulfate (inorganic coagulant) and the organic antioxidant used in the process does not provide a stable final product. Therefore, a need arose to find a formulation that when used in the treatment of pumped water, does not contain iron, or that reduces the iron content in the product by at least 50%.

Based on these needs an effort was made to identify an organic coagulant that meets certain criteria and provides comparable results to the use of ferric sulfate, e.g., speed of reaction, clarification, floc size, compaction, dosage, and price. Therefore, one of the goals in this work was to find organic alternatives to the inorganic coagulants in the treatment of pumped water in the fish industry.

In addition, the use of an organic coagulant brings many benefits including zero metal contributions to the fishmeal or flour, elimination of reductions in the use of chelants, no use of alkalis to neutralize the pH of the pumping water or effluent, lower moisture in the dehydrated cake, better stability in the temperatures of the fishmeal produced, better performance of antioxidants, can help prevent corrosion in sludge pipes, tanks, dryers, etc. . . . .

Accordingly, it is desirable to provide compositions and methods that provides all of the qualities outlined above. Another objective is to provide an organic product that allows for equal or better performance than the inorganic coagulants used today and using the same or lower doses. The desired result is to have “zero” metals (Fe, Al, Cd, etc.) in the formulation, allowing for a more stable process and a better quality finished product.

Other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Compositions are provided for the solid-liquid separation of suspended fish solids from the pumping water in the fishing industry. More particularly, the composition includes one or more organic coagulants, such as polyvinylamine (PVAM), one or more flocculants, and pumping water.

A method for solid-liquid processing of pumping water from the fishing industry is also provided. The method consists of treating pumping water including fish fat or oil, fish remains and colloidal particles, which constitute the total soluble solids (TSS) in the pumping water, among others. After recovering the larger solids and the free and emulsified fat, we are left with all the soluble solids in the pumping water which must be chemically treated with a composition that includes an organic coagulant comprising polyvinylamine and a flocculant. After the chemical treatment, a clarified water is obtained ready to be returned to the marine ocean. A cake is also obtained comprising the recovered total soluble solids. This cake can then undergo further processing, for example, to make fish meal.

### BRIEF DESCRIPTION OF THE DRAWINGS

The present disclosure will hereinafter be described in conjunction with the following drawing figures, wherein like numerals denote like elements, and wherein:

FIG. 1, represents the production process diagram for fishmeal and fish oil. In it we see two simultaneous processes. One is the main process for fishmeal and fish oil. And the other is the process for recovering solids from pumping water, which is called the Environmental Management and Adaptation Program (PAMA) and its use.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as being within a range of normal tolerance in the art, for example within 2 standard deviations of the mean. “About” can be understood to be within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

Provided is a composition for the solid-liquid separation of suspended solids found in the pumping water in the fishing industry. More particularly, the composition contains an organic coagulant based on polyvinylamine (PVAM), used in combination with a flocculant.

In some aspects of the composition, the suspended solids in the pumping water comprises from about 2 wt. % to about 4 wt. % total soluble solids, from about 0.1 wt. % to 0.5 wt. % fish fat, from about 1 wt. % to about 2 wt. % fish ash and soluble protein, and from about 90% to about 98% water.

In other aspects of the composition, the organic coagulant can be present in an active amount of from about 10 ppm to about 2000 ppm.

In yet other aspects of the composition, the flocculant is an anionic flocculant chosen from acrylamides, salts of acrylates, and combinations thereof.

In other aspects of the composition, the organic coagulant is polyvinylamine and the flocculant is based on acrylamide and sodium acrylate.

In yet other aspects of the composition, the organic coagulant comprising PVAM can be added prior to, subsequent to, or simultaneously with the flocculant.

In some aspects, the chemical treatment comprises the use of the PVAM-based organic coagulant independently and/or with other additional organic and/or inorganic coagulants, in separate use or as mixtures, added before, after or simultaneously, such as polyDADMAC, polyamines, tannins, chitosans, chitosan/aluminum, ferric sulfate, ferric chloride, aluminum sulfate, polyaluminum chloride and/or combinations thereof, in greater or lesser proportion.

Also provided is a method of separating fish solids or the total soluble solids (TSS) from pumping water in the production of fishmeal and oil. The pumping water comprises fish fat or oil, fish remains, and colloidal particles. The pumping water containing the suspended fish solids is chemical treated with a treatment that includes an organic coagulant and one or more flocculants. The treated pumping water then undergoes a solid-liquid separation process, separating the fish fat from the total soluble solids (TSS) in the pumping water.

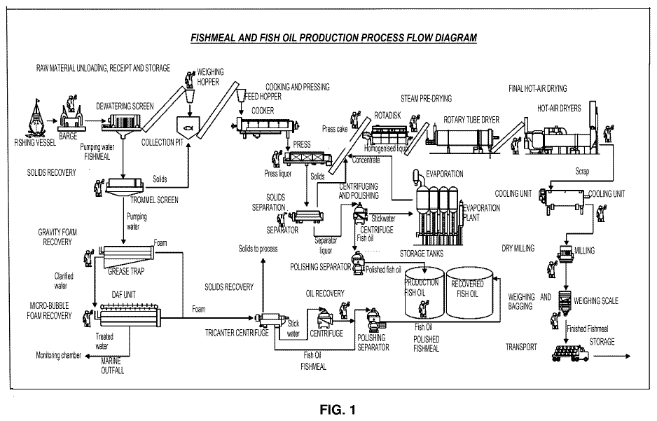

The present separation process can involve several steps as follows (See FIG. 1): Step 1—Rotary filters (trommel) can be used in this first step for the physical recovery of the largest particles found in the pumping water, e.g., passed through a 0.5 mm sieve; Step 2—Static grease trap removes a portion of grease or oil using density difference, i.e., free grease floats and the free grease that rises to the surface is removed; Step 3—Dynamic grease trap removal of additional grease or oil through dissolved air flotation cells and microbubbles; Step 4—Chemical treatment of the resulting pumping water through the addition of an organic coagulant and flocculant in a chemical DAF cell. This results in a clarified water and a sludge being produced. The resulting clarified water obtained from this process is returned to the marine emitter because it complies with the maximum limits permissible by the environmental entity. The sludge obtained from the chemical DAF cell goes to a decanter or tricanter (depending on the process line), where a dehydrated sludge, water and oil are obtained, depending on the equipment used.

The current method involves separating suspended fish solids from pumping water in the fishing industry. In particular, a pumping water comprising suspended fish solids is treated with a composition comprising an organic coagulant and one or more flocculants. The suspended fish solids can be separated from the pumping water thereby producing a clarified water and a sludge based on the recovered solids.

In some aspects of the method, the pumping water can be the water used to transport fish to a processing plant. The physicochemical characteristics of the pumping water depend on the capture time, the quality of the raw material, the seasonality of the fishing and the pump used to transport the raw material.

In some aspects of the method, the pumping water contains from about 2 wt. % to about 4 wt. % total soluble solids, from about 0.1 wt. % to 0.5 wt. % fish fat, from about 1 wt. % to about 2 wt. % fish protein, from about 1 wt. % to about 2 wt. % fish ash and soluble protein, and from about 90% to about 98% water.

In some aspects of the method, a portion of the fish fat and suspended solids larger than about 500 μm, are separated from the pumping water prior to treating the pumping water with the composition.

In yet other aspects of the method, the portion of fish fat and suspended solids larger than 500 μm are separated from the pumping water by a filtration and/or floatation step.

In other aspects of the method, the sludge can be processed to produce fishmeal.

In some aspects of the method, the humidity of the recovered sludge is reduced by 4-8% compared to traditional formulations.

In other aspects of the method, the pumping water contains from about 2 wt. % to about 4 wt. % total soluble solids, from about 0.1 wt. % to about 0.5 wt. % fish fat, from about 1 wt. % to about 2 wt. % fish protein, from about 1 wt. % to about 2 wt. % fish ash and soluble protein, and the remainder water.

### EXAMPLES

Studies were done using pumping water having the properties as outlined in Table 1.

### Example 1—Solids Recovery

Industrial solids recovery treatment tests were carried out in chemical cell with pumping water containing emulsified fish fat and soluble solids as outlined in Table 1.

TABLE 1
Properties of the Pumping Water

| | | | |
|---|---|---|---|
| SST | 32-79 | g/L | 2.8% |
| Fat | 0.16-7.5 | g/L | 0.10% |

| | | |
|---|---|---|
| Total Protein | NR | 1.00% |

| | | | |
|---|---|---|---|
| Soluble Protein | 0.3-7.5 | g/L | NR |

| | | |
|---|---|---|
| Ash | NR | 1.4% |
| Biological | NR | 4,600 ppm |
| Oxygen Demand | | |

| | | | |
|---|---|---|---|
| Chemical | 490-12,600 | ppm | 35,200 ppm |
| Oxygen Demand | | | |

| | | |
|---|---|---|
| Potential Hydrogen | NR | 6.2 |

Treatment of the pumping water were compared using 1) a composition that included an organic coagulant based on polyvinylamine (PVAM) and anionic flocculant; and 2) a composition that included inorganic coagulant ferric sulphate and an anionic flocculant as the process standard. For both cases, an anionic acrylamide/sodium acrylate copolymer flocculant was used in combination with the coagulant. See Table 2 below for the solids recovery.

TABLE 2
Solids Recovery

| | | | | Organic | | |
|---|---|---|---|---|---|---|
| | Incoming Effluent | | | Coagulant | | |
| | Total | | | (PVAM | | |
| | Soluble | | Flow | composition) | Outgoing Effluent | |
| | Solids (TSS) | | Rate | Dose | SST | |
| Sample | (ppm) | pH | (m³) | (ppm) | (ppm) | pH |
| 1 | 28000 | 6.89 | 6.4 | 750 | 214 | 6.79 |
| 2 | 15000 | 6.75 | 6.3 | 750 | 575 | 6.60 |
| 3 | 9300 | 7.25 | 6.4 | 290 | 164 | 7.10 |
| 4 | 7200 | 7.80 | 6.4 | 380 | 46 | 7.75 |

As can be seen in the Table 2, pumping water when treated with the composition containing the organic coagulant maintained a stable pH, e.g., the composition works adequately for the type of effluent, regardless of whether it has a high or low content of total soluble solids.

The present results were compared with historical results using ferric sulphate at dosages between 1000-1500 ppm, depending on the quantity of total soluble solids in the water to be treated. Results indicated that the composition containing polyvinylamine had an equal or better performance than the composition containing ferric sulfate. In addition, samples containing the PVAM composition had excellent performance in generating a very compact floating sludge and showed a more effective solid-liquid separation complying with the maximum permissible limits (LMP's) of the effluent throughout the separation process.

In addition, results show, when compared with historical results, that a lower dosage of the organic coagulant can be used when compared with the inorganic coagulant, i.e., 290 ppm to 2000 ppm, which demonstrates its effectiveness in the treatment of effluents from the fishing industry.

Finally, the total soluble solids (TSS) of the incoming effluent were quite variable from 7000 ppm to 28000 ppm, despite having a high TSS load. The composition containing the organic coagulant maintained an excellent performance, obtaining output effluents of 575 ppm to 46 ppm of TSS.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A composition for the chemical treatment of suspended fish solids in water in the fishing industry comprising: an organic coagulant comprising polyvinylamine, one or more flocculants, and water containing suspended fish solids.

2. The composition according to claim 1, wherein the suspended fish solids in the water comprises from about 2 wt. % to about 4 wt. % total soluble solids, from about 0.1 wt. % to 0.5 wt. % fish fat, from about 1 wt. % to about 2 wt. % fish ash and soluble protein, and from about 90% to about 98% water.

3. The composition according to claim 1, wherein the organic coagulant comprising polyvinylamine is present in an active amount of from about 10 ppm to about 2000 ppm of the total composition.

4. The composition according to claim 1, wherein the one or more flocculants is an anionic flocculant.

5. The composition according to claim 1, wherein the flocculant is present in an amount of from about 400 ppm to about 600 ppm.

6. The composition according to claim 1, wherein the organic coagulant is polyvinylamine and the flocculant is an acrylamide, a sodium acrylate, or a combination thereof.

7. The composition according to claim 1, further comprising additional organic and/or inorganic coagulants.

8. The composition according to claim 7, wherein the additional coagulants are chosen from polyDADMAC, polyamines, tannins, chitosans, chitosan/aluminum, ferric sulfate, ferric chloride, aluminum sulfate, polyaluminum chloride, and combinations thereof.

9. The composition according to claim 1, wherein the water containing suspended fish solids is pumping water.

10. A method of separating fish solids from water comprising:
providing a water comprising suspended fish solids;
treating the water with a composition according to claim 1;
separating the suspended solids from the water producing a clarified water and a sludge based on the recovered suspended solids.

11. The method according to claim 10, wherein the water contains fish solids comprising from about 2 wt. % to about 4 wt. % total soluble solids, from about 0.1 wt. % to 0.5 wt. % fish fat, from about 1 wt. % to about 2 wt. % fish ash and soluble protein, and from about 90% to about 98% water.

12. The method according to claim 10, wherein the organic coagulant of the composition is added to the water prior to the one or more flocculants.

13. The method according to claim 11, wherein a portion of fish fat and suspended solids larger than about 500 μm, are separated from the water prior to treating the water with the composition.

14. The method according to claim 11, wherein the portion of fish fat and suspended solids larger than about 500 μm, are separated from the water by a filtration and/or floatation step.

15. The method according to claim 10, wherein the sludge can be processed to produce fishmeal.

16. The method according to claim 10, wherein the water is a pumping water used to transport the suspended fish solids to a processing plant.

17. The method according to claim 10, wherein the humidity of the recovered suspended solids is reduced by from about 4 wt. % to about 8 wt. % when compared to traditional formulations.
